(19) United States
(12) Patent Application Publication
(10) Pub. No.: US 2010/0010674 A1
(43) Pub. Date: Jan. 14, 2010

(54) METHOD FOR THE DETECTION OF A CASTING CURVE FOR A ROBOT CONTROLLER, AND DETECTION SYSTEM THEREFOR

(75) Inventor: Dirk Hablick, Woelfersheim (DE)

Correspondence Address: DARBY & DARBY P.C., P.O. BOX 770, Church Street Station, New York, NY, 10008-0770, US

(73) Assignee: ABB AG, Mannheim (DE)

(21) Appl. No.: 12/374,982

(22) PCT Filed: Jul. 7, 2007
(86) PCT No.: PCT/EP07/06047

§ 371 Date: Jan. 23, 2009

(30) Foreign Application Priority Data
Jul. 24, 2006 (DE) 10 2006 034 044.2

(51) Int. Cl. B25J 9/22

(52) U.S. Cl. 700/264; 380/255; 901/5; 901/30

(57) ABSTRACT

A method for detecting a casting curve for a controller of a robot guiding a pouring spoon includes the steps of manually pouring a smelt from the pouring spoon using a remote control apparatus, detecting and storing at least one time characteristic, and making available the at least one stored time characteristic for use in the robot controller. The at least one time characteristic includes at least of a first time characteristic of a movement of the robot and a second time characteristic of weights of the poured smelt during the pouring. In addition, a method for casting cast parts using a robot having a pouring spoon and a robot controller is disclosed as is a robot system.

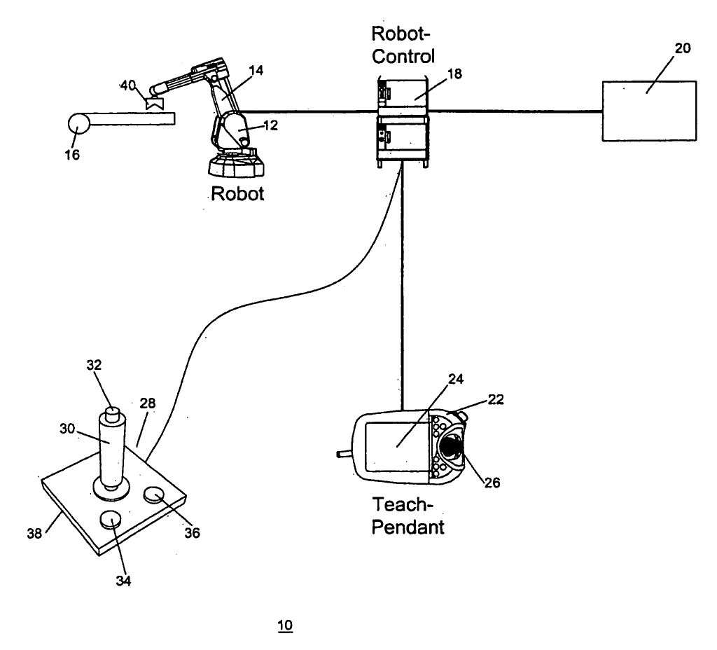

The invention relates to a method for detecting a casting curve for a robot controller of a robot which guides a pouring spoon. In addition, the invention relates to a detection system for detecting a casting curve.

In the past, casting processes in which the required volume of smelt does not assume excessively high values were carried out by one or more appropriately trained persons. For this purpose, smelt, for example liquid metal, is first removed from a holding furnace by means of an appropriate pouring ladle or a pouring spoon and cast, in accordance with the “feel and experience” of the staff, into a molding box having the shape to be cast. This procedure is accordingly complex and requires the staff to be just as attentive as before during each renewed casting, as the result of the casting generally depends on an individual casting process which is dependent on the casting mold. In addition, in a procedure of this type, the dwell time of the smelt in the casting vessel (pouring spoon, ladle) is comparatively long, so that a correspondingly thick oxide skin forms on the smelt. The physical and mental exertion placed on the staff by the manual casting process is accordingly high.

Starting from this prior art, the object of the invention is to disclose an automated method for casting using a robot. It is also the object of the invention to disclose a corresponding robot system for carrying out the method.

According to the invention, the method for casting cast parts using a robot has a pouring spoon and a robot controller, a casting curve being consulted for controlling the sequences of movement of the robot and the pouring spoon.

All data relevant to the robot controller for the casting process are contained in the casting curve. That is for example the time characteristic of the movement of the robot, including the movement of the pouring spoon or else the time characteristic of the poured weights or the time characteristic of the reduction in weight of the smelt in the pouring spoon. In this way, once filed in the robot controller, a casting curve can be retrieved again and again, so that a casting process programmed in this way can be repeated again and again with constant casting quality. In this case, the casting curve can be carried out for example by programming individual movement steps for the individual robot axis and corresponding movement steps for the pouring spoon. Off-line programming of the robot controller is, inter alia, possible for this purpose.

However, the invention proposes a method for detecting a casting curve for a robot controller of a robot which guides a pouring spoon, characterized in that a smelt is manually poured from the pouring spoon by means of a remote control apparatus, the time characteristic of the movement of the robot and/or the time characteristic of the poured weights being detected and stored during the pouring, and the stored time characteristic being made available for use in the robot controller.

This ensures that the “experience” which an appropriately trained person has in the process of pouring in the manual range is reflected in the casting curve for the subsequent use in the robot. In addition, the method according to the invention saves a lot of time for programming the sequences of movement and delivers consistently good casting results. The remote control apparatus used can be both generally known robot hand-held controllers, which are frequently part of modern robot systems, but also separate remote control apparatuses, such as joysticks or manipulators, which are accordingly connected to the robot controller in parallel or separately via an interface. Particularly simple programming in the scope of a casting curve is achieved in this way. Dispensed with in particular are also the initiation and training in the often specific systems for a robot or for a robot controller using remote control apparatuses with which the operator is already familiar.

The invention also allows the removal of the smelt from a supply vessel by way of the pouring spoon, for example in a holding furnace, in which casting curves are filed.

The object is also achieved by a robot system for detecting a casting curve for a robot controller of a robot, with a pouring spoon attached to the robot and with a robot controller, a remote control apparatus being connected to the robot controller.

In this case, the remote control apparatus can be different from a robot hand-held control apparatus or else be what is known as a “teach pendant”. Preferably, however, the remote control apparatus is connected in parallel or as an alternative to the robot hand-held control apparatus. In this way, the staff can also carry out the manual casting process using the remote control apparatus with which they are familiar.

If the time characteristic of the movement of the robot is detected and stored, the robot controller can also be used for this purpose.

If the time characteristic of the poured weights is detected, provision is made in the robot system according to the invention for the poured weights to be able to be detected by means of weight sensors, with the measurements of which a respective time signal is associated.

In this case, the time signal for each measurement can be associated with the robot controller or with a separate measuring computer or with a corresponding measuring device.

Further advantageous configurations of the subject-matter of the invention are disclosed in the further dependent claims.

The invention, its advantages and further improvements to the invention will be described in greater detail with reference to the exemplary embodiment illustrated in the drawing, in which:

the single FIGURE is a sketch of a robot system.

The single FIGURE shows the example of a robot system 10 according to the invention with an industrial robot 12 which carries a pouring spoon 16 on a robot arm 14. The robot 12 is connected to a robot controller 18 which controls the sequences of movement of the industrial robot 12 and monitors, utilizes or else optionally stores feedback and signals of sensors or the drives of joints of the robot arm 14. In addition, the robot controller 18 is configured for the communication of data with further apparatuses by corresponding interfaces. Thus, in the selected example, it is possible to exchange data with a guide system 20 via a first interface. In this way, new or altered working programs for the robot can for example be loaded into the robot controller.

A robot hand-held control apparatus 22 is also connected to the robot controller 18 via a second interface. In many cases, robot hand-held control apparatuses of this type are configured so as to have a screen 24 and a plurality of control buttons 26, so that generally speaking specific knowledge is necessary to operate a robot using a robot hand-held control apparatus 22 of this type. For this purpose, the robot hand-held control apparatus 22 offers a large number of function and control selection options, for example to program a sequence of movements of the robot into the robot controller.

Furthermore, a joystick 28, which serves as a remote control apparatus for the robot controller, is connected to the robot controller 18 via a third interface. In the sketch, the connection is indicated as a cable connection, although a connection of this type can also take place wirelessly, for example via radio. The selected joystick 28 has a control lever 30 with a first button 32 and a base element 38 on which the control lever 30 is arranged and in addition two further buttons, namely a second button 34 and a third button 36, are arranged.

The method according to the invention for detecting a casting curve for a robot controller of a robot which guides a pouring spoon is carried out, using the robot system 10 described hereinbefore, as follows. The movements of the robot are controlled by the joystick 28. In this case, the operator will use the control lever 30 for moving the robot left, right, forward and backward, the robot controller 18 ensuring that the pouring spoon 16 maintains its spatial orientation. Further movements are caused by the first button 32, optionally together with further buttons 34, 36 or the control lever 30. First, a smelt is removed from a corresponding vessel in a holding furnace (not shown in greater detail in this FIGURE) using the pouring spoon 16. The scooping movement is in this case caused by the second 34 and the third button 36. The operator then carries out the manual pouring into a molding box (also not shown in greater detail in this FIGURE) containing the casting mold. A particular advantage is that the robot controller remains in “automatic” operating mode during the manual pouring. In this operating mode, a control program conventionally defines the sequences of movement of the robot. In this case, however, the automatic operation expects the data input through the manual pouring. Equally, the safety functions of the robot can remain switched on. In this case, throughout the pouring process, the time characteristic of the movement of the robot is detected by the robot controller 18 and filed in a corresponding data memory. It is however equally conceivable for the guide system to obtain this data directly or via the robot controller 18 and the time characteristic to be stored in the corresponding data memories of the guide system 20 of the movement of the robot.

As an alternative to the time characteristic of the movement of the robot, it is also within the idea of the invention to detect the time characteristic of the poured weights. This requires corresponding weight or force sensors which are represented symbolically in the single FIGURE by the intermediate piece 40, namely as a connecting element between the robot arm 14 and the pouring spoon 16.

After the completion of the pouring, storage of the time characteristic of the movement of the robot is also completed and made available for use in the robot controller.

As an alternative to the joystick 28, it is however also possible to use the robot hand-held control apparatus 22 for the first manual pouring of the smelt.

The casting curve obtained in one of the foregoing ways can be retrieved again and again in a particularly simple manner in the process of pouring for the same casting processes, so that a constant casting quality is achieved. For this purpose, the casting curve must merely be consulted for controlling the sequences of movement of the robot 12 and of the pouring spoon 16.

### LIST OF REFERENCE NUMERALS

10 Robot system
12 Industrial robot
14 Robot arm
16 Pouring spoon
18 Robot controller
20 Guide system
22 Robot hand-held control apparatus
24 Screen
26 Control button
28 Joystick
30 Control lever
32 First button
34 Second button
36 Third button
38 Base element
40 Intermediate piece

1-13. (canceled)

14. A method for detecting a casting curve for a controller of a robot guiding a pouring spoon, the method comprising:
manually pouring a smelt from the pouring spoon using a remote control apparatus;
detecting and storing at least one time characteristic, the at least one time characteristic including at least of a first time characteristic of a movement of the robot and a second time characteristic of weights of the poured smelt during the pouring; and
making available the at least one stored time characteristic for use in the robot controller.

15. The method as recited in claim 14, wherein the at least one time characteristic is stored in a data memory external to the robot controller.

16. The method as recited in claim 14, wherein the at least one time characteristic is stored in the robot controller.

17. The method as recited in claim 14, further comprising removing the from a supply vessel using the pouring spoon before the manually pouring.

18. The method as recited in claim 14, further comprising transmitting data from the remote control apparatus to the robot controller.

19. The method as recited in claim 18, further comprising exchanging data between the remote apparatus to the robot controller.

20. The method as recited in claim 18, wherein the data is in encrypted form.

21. The method as recited in claim 14, further comprising a robot hand-held control apparatus and wherein the remote control apparatus is operated independently of the robot hand-held control apparatus.

22. A method for casting cast parts using a robot having a pouring spoon and a robot controller; the method comprising:
manually pouring a smelt from the pouring spoon using a remote control apparatus;
detecting and storing at least one time characteristic, the at least one time characteristic including at least of a first time characteristic of a movement of the robot and a second time characteristic of weights of the poured smelt during the pouring;
determining a casting curve using the at least one stored time characteristic;
consulting the casting curve for controlling sequences of movement of the robot and the pouring spoon.

23. A robot system comprising:
a robot;
a pouring spoon attached to the robot;
a robot controller operatively connected to the robot and configured to control the robot;
a remote control apparatus being operatively connected to the robot controller and configured to control a manual pouring of a smelt from the pouring spoon such that at least one time characteristic can be detected and stored, the at least one time characteristic including at least of a first time characteristic of a movement of the robot and a second time characteristic of weights of the poured smelt during the pouring, wherein the at least one time characteristic is useable to detect a casting curve.

24. The robot system as recited in claim 23, further comprising a robot hand-held control apparatus and wherein the remote control apparatus is connected to the robot hand-held control apparatus.

25. The robot system as recited in claim 24, wherein the remote control apparatus is connected in parallel to the robot hand-held control apparatus.

26. The robot system as recited in claim 23, further comprising a plurality of weight sensors configured to perform measurements of the weights of the poured smelt during the pouring, the second time characteristic being determined using the measurements associated with a respective time signal.

27. The robot system as recited in claim 23, wherein the robot controller is configured to detect the first time characteristic.

28. The robot system as recited in claim 23, wherein the robot controller has a detection module configured to at least one of detect and to store data via the at least one time characteristic.

29. The robot system as recited in claim 23, further comprising a data processing unit having a detection module configured to at least one of detect and to store data via the at least one time characteristic.
